(19) United States
(12) Patent Application Publication
(10) Pub. No.: US 2015/0294378 A1
(43) Pub. Date: Oct. 15, 2015

(54) CUSTOMIZING EVALUATION INFORMATION PRESENTATION

(71) Applicant: Alibaba Group Holding Limited, George Town (KY)

(72) Inventor: Zengguang Liu, Hangzhou (CN)

(21) Appl. No.: 14/677,132

(22) Filed: Apr. 2, 2015

(30) Foreign Application Priority Data
Apr. 9, 2014 (CN) 201410140675.6

(51) Int. Cl. G06Q 30/02; G06Q 30/06

(52) U.S. Cl. CPC G06Q 30/0282; G06Q 30/0623

(57) ABSTRACT

Customizing evaluation information presentation is disclosed, including: receiving a request associated with a current user to view a plurality of evaluation information associated with a current product; obtaining attribute information associated with the current user; obtaining attribute information associated with publisher users corresponding to respective ones of the plurality of evaluation information associated with the current product; determining a degree of attribute information match between the current user and each of a subset of the publisher users; and presenting at least a subset of the plurality of evaluation information associated with the current product based at least in part on respective degrees of attribute information match between the current user and each of the a subset of the publisher users.

### CROSS REFERENCE TO OTHER APPLICATIONS

This application claims priority to People's Republic of China Patent Application No. 201410140675.6 entitled A METHOD AND A SYSTEM FOR PROVIDING USER EVALUATION INFORMATION, filed Apr. 9, 2014 which is incorporated herein by reference for all purposes.

### FIELD OF THE INVENTION

The present application relates to a field of Internet data presentation. In particular, the present application relates to techniques for providing user evaluation information.

### BACKGROUND OF THE INVENTION

As e-commerce transaction platforms are continually improved and as the technology of traditional and mobile communications rapidly develop, more and more people are using online shopping to obtain the products they need. As such, this technology has provided people with tremendous convenience.

An advantage of e-commerce transaction platforms is the fact that users may select and purchase the products they need without leaving their homes. However, in another respect, this form of remote shopping has also become a drawback of e-commerce transaction platforms. That is, when users purchase items online, they cannot see or interact with the actual products that they purchase. For example, unlike shopping in the real world, when shopping via an e-commerce transaction platform, users cannot try on clothes or test out products, etc. Generally, when shopping via an e-commerce transaction platform, a user can only evaluate a product based on the descriptions of the product that are provided by the seller of the product. However, it is possible that the actual product differs from the descriptions provided by its seller. For example, the color and/or quality of the actual product might be different from its description. As a result of such discrepancies between the seller provided descriptions of a product and the actual product itself, disputes may arise between the buyer and seller users of the product.

In order to increase the amount of product-related information that is available to buyer users, e-commerce transaction platforms generally also provide a user evaluation system. In a user evaluation system, previous buyer users of a product are permitted to go to the transaction platform to submit evaluation information relating to the product. For example, such a piece of evaluation information may include a rating, descriptions of the quality of the actual product, the buying experience, and so on. For example, a buyer user buys a down coat from an e-commerce transaction platform and after receiving the coat, discovers that the quality is good and that the size is just right. Therefore, the buyer user may submit a “Positive comment” in the evaluation information for the down coat product on the e-commerce transaction platform and can further enter the following text in the evaluation as follows: “Quality not bad, size is quite accurate, no difference in color,” etc. Thus, when another buyer user browses the detailed information web page of this down coat product, this set of evaluation information can be presented to the user, among other sets of evaluation information. By using the user evaluation system, a potential buyer may obtain information about a product's quality and customer experience from the evaluations of the product that were submitted by previous buyer users. Moreover, a potential buyer may use evaluation information submitted by previous buyer users as a factor in assessing whether or not to purchase a product. By maintaining a user evaluation system for an e-commerce transaction platform, the number of disputes between buyer and seller user may be reduced and the number of product returns may also decrease.

However, conventionally, when a potential buyer views the evaluation information regarding a product on that product's detailed information web page, the evaluations are typically displayed in chronological order of when the evaluations were submitted. The current potential buyer would therefore likely spend a lot of time manually browsing the evaluations to get a sense of whether the product is suitable for his or her own needs.

Therefore, it is desired to improve the manner in which evaluation information regarding a product is displayed for a potential buyer.

### BRIEF DESCRIPTION OF THE DRAWINGS

Various embodiments of the invention are disclosed in the following detailed description and the accompanying drawings.

FIG. 1 is a diagram showing an embodiment of a system for customizing evaluation information presentation.

FIG. 2 is a flow diagram showing an embodiment of a process for customizing evaluation information presentation.

FIG. 3 is a flow diagram showing an embodiment of a process for customizing evaluation information presentation.

FIG. 4 is a diagram showing an embodiment of a system for customizing evaluation information presentation.

FIG. 5 is a diagram showing an embodiment of a system for customizing evaluation information presentation.

FIG. 6 is a functional diagram illustrating an embodiment of a programmed computer system for implementing customizing evaluation information presentation.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of customizing evaluation information presentation are described herein. In various embodiments, a request associated with a current user to view a plurality of sets of evaluation information associated with a current product is received. In some embodiments, attribute information associated with the current user is obtained. In various embodiments, attribute information associated with each publisher user that had submitted a set of evaluation information associated with the current product is also obtained. Because it is assumed that sets of evaluation information associated with the current product that were authored by other users who are similar to the current user would be of greater interest and/or greater use to the current user, in various embodiments, the attribute information obtained for the current user is compared against the attribute information obtained for each publisher user. A degree of attribute information match, which comprises a value that represents the overall similarity between a current user and a publisher user, is determined for the current user and each publisher user based on comparing the users' attribute information. In various embodiments, the sets of evaluation information are presented to the current user, in which sets of evaluation information authored by publisher users with greater degrees of attribute information match with the current user are presented in a more prioritized manner (e.g., in higher ranked positions than sets of evaluation information authored by publisher users with lower degrees of attribute information match with the current user).

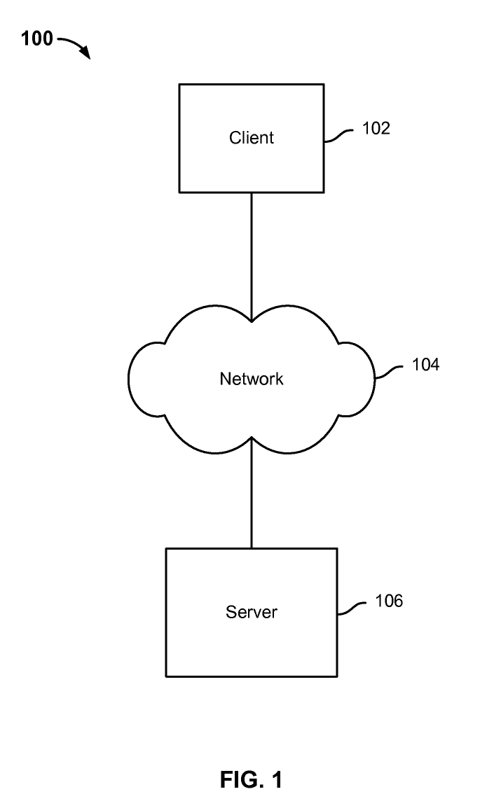

FIG. 1 is a diagram showing an embodiment of a system for customizing evaluation information presentation. In the example, system 100 includes client device 102, network 104, and server 106. Network 104 includes high-speed data networks and/or telecommunications networks.

A user may access an e-commerce transaction platform using client device 102 to browse through products that are available for purchase. Examples of client device 102 comprise a desktop computer, a laptop computer, a mobile device, a smartphone, a tablet device, or any other type of computing device. For example, the e-commerce transaction platform may comprise a website and/or an application. In various embodiments, the e-commerce transaction platform is supported by server 106.

In various embodiments, the e-commerce transaction platform enables users to submit sets of evaluation information for products for which they have purchased and/or used. A potential buyer user (or sometimes referred to as a “current user”) may request to view the detailed information page of a particular product that he or she is interested in at the e-commerce transaction platform. In some embodiments, sets of evaluation information associated with the product may be displayed at the detailed information page itself or the sets of evaluation information associated with the product may be displayed at a separate page that is linked from the detailed information page.

In various embodiments, in response to a request to view the sets of evaluation information associated with the product, the attribute information associated with the current user and with each user who has authored each set of evaluation information (each “publisher user”) is obtained. Prior to presenting the sets of evaluation information associated with the product to the current user, a degree of attribute information match is determined between each pair including the current user and a publisher user. In various embodiments, the degree of attribute information match between each pair of the current user and a publisher user represents an overall similarity between the two users. It is assumed that the current user would be more interested in sets of evaluation information associated with the product that have been authored by publisher users who are similar to the current user. As such, the sets of evaluation information corresponding to publisher users with higher degrees of attribute information match with the current user are presented in a prioritized manner to the current user so that these presumably more relevant sets of evaluation information are presented to the current user sooner and/or more conspicuously than other sets of evaluation information corresponding to publisher users with lower degrees of attribute information match. In this way, the presentation of the sets of evaluation information associated with the product is customized for each current user based on the attribute information associated with that particular current user.

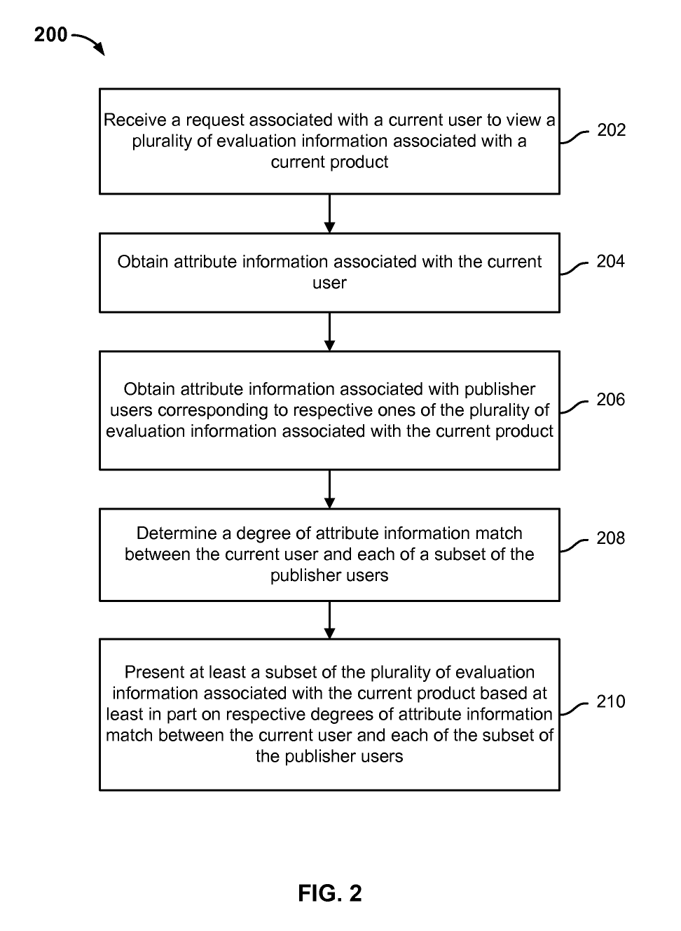

FIG. 2 is a flow diagram showing an embodiment of a process for customizing evaluation information presentation. In some embodiments, process 200 is implemented at system 100 of FIG. 1.

At 202, a request associated with a current user to view a plurality of evaluation information associated with a current product is received.

In various embodiments, a current user comprises a buyer user who is browsing a current product at an e-commerce transaction platform. For example, the current user may have performed a search via the platform's homepage and/or portal and has selected (e.g., clicked on) a link or other selectable element associated with the current product to view further information associated with the current product. In response to the user's selection, a request for the detailed information page associated with the product is generated and sent to a server associated with the e-commerce transaction platform. In various embodiments, the detailed information page associated with the product includes a description (e.g., text and/or images) of the current product and also sets of evaluation information associated with the current product that were submitted/published by previous buyer users of the current product. Each set of evaluation information associated with the current product was submitted/published by a corresponding previous buyer user or is sometimes referred to as a corresponding “publisher user” of the current product and may include a rating and an evaluative description (e.g., text and/or images) of the current product. For example, the sets of evaluation information associated with the product are either to be presented directly at the detailed information page associated with the product and/or displayed at a dedicated evaluation page that is linked from the detailed information page associated with the product (e.g., via a “Detailed Evaluation Information” button that is displayed at the detailed information page associated with the product). As such, the sets of evaluation information associated with the current product are retrieved from storage.

As will be described in further detail below, the retrieved sets of evaluation information associated with the current product are to be screened and/or ranked based on the attribute information associated with the current user before they are displayed for the current user.

At 204, attribute information associated with the current user is obtained.

In various embodiments, attribute information of the current user may include multiple dimensions, where each dimension comprises a different attribute. Examples of dimensions of attribute information of the current user may include the following: user height, weight, age, preferences, credit rating, skin type, education, occupation, and geographic location. In various embodiments, obtained attribute information for the current user may include one or more dimensions. The attribute information of the current user may be obtained using one or a combination of techniques.

In some embodiments, the attribute information of the current user may be determined from storage. For example, an e-commerce transaction platform often requires users to register accounts before they can conduct transactions. When a user registers an account, the user is generally asked to provide personal information, including, for example, user height, weight, age, preferences, credit rating, skin type, education, occupation, and/or geographic location. Therefore, the attribute information associated with the current user may be obtained from the stored personal information that was provided by the current user at the time of registering an account with the e-commerce transaction platform.

In some embodiments, the attribute information of the current user may be extracted from various pieces of information that were submitted by the current user through using the e-commerce transaction platform. For example, a user may not have provided his height and weight information as part of his personal information during the account registration process but the user may have provided such height and weight information in a submitted set of evaluation information for a product. For example, if the current user's geographic location information has not been provided during the account registration process with the personal information, then the shipping address provided by the user can be obtained by querying the current user's stored order history. The shipping address is then extracted from the current user's stored order history and used as the geographical location associated with the current user. If there are multiple shipping addresses found within the current user's stored order history, then the shipping address that is used most often, the shipping address that was most recently used, or the shipping address that was selected as the default address can be extracted and used as the geographical location associated with the current user.

In some embodiments, the attribute information of the current user may be obtained through data modeling. In order to increase the user request response speed, statistics including the attribute information for each user can be compiled and used to establish a user attribute information database. Each user in this database may be represented by his or her account identifier (ID). One account ID may correspond to attribute information in one or more dimensions. Thus, when it is needed to display sets of evaluation information associated with the current product to the current user, the database may be queried so as to retrieve specific user attribute information associated with the account ID of the current user.

The following is a specific example of obtaining attribute information associated with the current user: before attribute information is attempted to be obtained for the current user, it is first determined whether the current user has logged/signed into the e-commerce transaction platform. If so, the account ID that he or she is currently logged into can be used to access the user attribute information corresponding to that account that is stored in the database. However, if it is determined that the current user has not logged/signed into the commerce transaction platform, a web browser stored client cookie associated with the current user is looked up. For example, a server associated with the e-commerce transaction platform can write user attribute information into a client cookie. Thus, if it is determined that the current user is not logged in, the client cookie associated with the e-commerce transaction platform can be checked to obtain user attribute information for the current user. For example, the user account ID can be written into a cookie and therefore, the user account ID can be acquired by checking the cookie information. Then, the user attribute information corresponding to the user account ID can be looked up in the server's database. In addition, if it is not possible to obtain the current user's geographic location from the current user's stored personal information, order history, or previously submitted evaluation information, then the current user's geographic location may be determined from the current user's Internet Protocol (IP) address. Or, alternatively, if the current user is using a client device that includes a positioning feature (e.g., a GPS module), then the current user's geographic location may be determined according to such a positioning feature from the client device.

At 206, attribute information associated with publisher users corresponding to respective ones of the plurality of evaluation information associated with the current product is obtained.

As mentioned above, each set of evaluation information associated with the current product was submitted/published by a corresponding publisher user. The attribute information corresponding to each publisher user corresponding to each set of evaluation information associated with the current product is obtained. In some embodiments, the attribute information corresponding to each publisher user corresponding to each set of evaluation information associated with the current product can be obtained using one or more techniques described above for obtaining attribute information for the current user. The attribute information of each publisher user may also include, for example, a user's height, weight, age, credit rating, and/or geographical location.

At 208, a degree of attribute information match is determined between the current user and each of a subset of the publisher users.

After the attribute information for the current user and each publisher user is obtained, a degree of attribute information match is determined between the current user and each of the publisher users. In various embodiments, the degree of attribute information match between the current user and a publisher user represents the degree to which the current user and a publisher user are similar to each other with respect to one or more attributes/dimensions and the likelihood that a set of evaluation information submitted by the publisher user may be of interest and/or of use to the current user. As will be described in further detail below, the degree of attribute information match between the current user and a publisher user can be used to determine which sets of evaluation information will be presented in a prioritized manner to the current user. In some embodiments, presenting a set of evaluation information in a prioritized manner to the current user includes presenting the set of evaluation information at all (as opposed to hiding the set of evaluation from view) to the current user and/or presenting the set of evaluation information in a higher ranking relative to other sets of evaluation information.

In some embodiments, the degree of attribute information match between the current user and a publisher user is determined along one dimension (one attribute). For example, just one attribute/dimension can be used to determine the degree of attribute information match between the current user and a publisher user if that is the only common attribute/dimension that could be obtained for both the current user and the publisher user and/or if that attribute/dimension is the only attribute/dimension that is selected for determining the degree of attribute information match between the current user and a publisher user. For example, if the attribute that is to be used as the basis for determining the degree of attribute information match was age, then the degree of attribute information match between the current user and a publisher user can be determined based on the similarity between the users' ages. For example, if the age of the current user is a1 and the age of a publisher user is a2, then the absolute value of the difference between the age attributes of these two users is: |a1−a2|. This absolute value of the difference serves as a measurement that is inversely proportional to the similarity between these two users. Any appropriate technique may be used to convert the absolute value of the difference between the same attributes of the current user and a publisher user into a similarity value between the two users. The similarity between the two users is directly proportional to the degree of age attribute match between the two users. Any appropriate technique may be used to convert the similarity value between the current user and a publisher user into a degree of attribute information match between the two users. As such, the smaller the absolute value of the difference in the two users' age attributes is, the greater the degree of age attribute match. For example, if two users are both 25 years old, then the absolute value of the difference is 0, and so the degree of age attribute match in this case is the maximum value. The similarities of attribute information in other attributes besides age can be calculated in a similar manner. For example, in the height dimension, if the height of the current user is 160 cm and the height of a publisher user is 161 cm, then the degree of height attribute match between the two users in the height dimension is relatively high.

In various embodiments and as will be described in further detail below, the degree of attribute information match between the current user and a publisher user is used to rank the publisher user's set of evaluation information in the presentation of sets of evaluation information to the current user at a product's detailed information web page.

In some embodiments, the degree of attribute information match between the current user and a publisher user is determined along multiple dimensions (multiple attributes). For example, multiple attributes/dimensions can be used to determine the degree of attribute information match between the current user and a publisher user if there are multiple common attributes/dimensions that could be obtained for both the current user and the publisher user and/or if multiple attributes/dimensions are selected for determining the degree of attribute information match between the current user and a publisher user. It is possible to determine the similarity between each individual dimension for the current user and the publisher user first and then combine (e.g., sum) the similarities corresponding to the respective dimensions to determine a degree of attribute information match between the two users. For example, a current user searches for “Shirts” on the e-commerce transaction platform. After selecting a certain shirt product among the search results, a detailed information page associated with the selected shirt product is accessed. On the detailed information page, he selects to view the “Detailed Evaluation Information” content to view the sets of evaluation information that were submitted by various publisher users regarding this shirt. In this scenario, prior to presenting the sets of evaluation information to the current user, the system can analyze the attribute information between the current user and the publisher user associated with each set of evaluation information and rank the sets of evaluation information based on their publisher users' respective degrees of attribute information match with the current user. For example, the sets of evaluation information associated with publisher users who have a higher degree of attribute information match with the current user will be ranked higher and will therefore be displayed in a prioritized manner. As such, the current user can view sets of evaluation information regarding the current product that were submitted by publisher users who are in the same age range and have similar height, weight, and/or shopping preferences, for example, as the current user earlier among the presented sets of evaluation information. This way, the current user can view the sets of evaluation information that may be more relevant to him or her first and allow him or her to better evaluate the current product given the prioritized presentations of sets of evaluation information submitted by similar other users.

As mentioned above, when the degree of attribute information match between the current user and a publisher user is determined along multiple attributes/dimensions, the similarity between the two users in each individual dimension may be determined first. Then, the similarities corresponding to respective dimensions may be weighted and combined to determine the degree of attribute information match between the current user and the publisher user. Attributes that are already numeric values can be used directly and attributes whose values are not already numeric values can be converted into numeric values. The similarity between the current user and the publisher user in each of those attributes/dimensions can be determined as being inversely proportional to the absolute value of the difference of those attributes' respective values. Other techniques of determining similarity between each attribute of the current user and a publisher user may be used as well.

In combining the determined similarities corresponding to respective ones of attributes between the current user and a publisher user, each similarity can be weighted first and then the weighted similarities can be summed together. A different weight may be assigned to the similarity of a different attribute based on a level of importance associated with the attribute. For example, the following example formula may be used to determine the weighted sum of various attributes' similarities between the current user and a publisher user:

S=Σᵢ₌₁ⁿ×aᵢ (1)

Where sᵢ represents the similarity between the current user and the publisher user in attribute i and aᵢ is the weight assigned to the similarity in attribute i.

For example, assume that the similarity in the age attribute/dimension between the current user and a publisher user is s1, the similarity in the height attribute/dimension is s2, and the similarity in the weight attribute/dimension is s3 and that the weights corresponding to the age attribute/dimension, the height attribute/dimension, and the weight attribute/dimension are a1, a2, and a3, respectively. In this example, the degree of match S between these two users may be expressed as:

S=s1×a1+s2×a2+s3×a3 (2)

In some embodiments, the weight corresponding to the similarity of each attribute may be predetermined. For example, the weight corresponding to the similarity of an attribute may be determined based on empirical values.

In some embodiments, the weights assigned to different attribute similarities may be different between different products and/or product categories. In some embodiments, the weights are set for different products and/or product categories using the product category to which the current product belongs and preset attribute similarity weight rules.

Below are examples in which weights assigned to different attribute similarities may differ based on the product category associated with the current product for which the sets of evaluation information are to be presented to a current user:

In a first example, if the current product falls within the category of apparel or of shoes, the current user, in viewing sets of evaluation information for the current product, may prefer to have a prioritized view of sets of evaluation information that were published by publisher users whose height and weight are similar to his or her own. Therefore, if the current product is in the apparel or shoes category, then, in some embodiments, similarities in the height and weight attributes/dimensions can be weighted more heavily in the degree of attribute information match determination between the current user and the publisher user.

In a second example, if the current product is a type of apparel or shoes with seasonal features/uses, the current user, in viewing sets of evaluation information for the current product, may prefer to have a prioritized view of sets of evaluation information that were published by publisher users in the same geographical location as the current user. For example, a down coat is an example of a product with seasonal features/uses because it is most likely worn/purchased during cooler seasons such as fall or winter. By giving a similarity in the geographical location attribute more weight, a current user can have a prioritized view of sets of evaluation information of other local users earlier among the displayed evaluation information and use this information to determine whether the current product is suitable for him or her. Therefore, if the current product is in the category of apparel or shoes with seasonal features/uses, the similarity in the geographical location attribute can be weighted more heavily in the degree of attribute information match determination between the current user and the publisher user.

In a third example, if the current product is in the cosmetics category, the current user, in viewing sets of evaluation information for the current product, may prefer to have a prioritized view of sets of evaluation information by publisher users of similar skin type and age. Examples of different skin types include: dry skin, oily skin, combination skin, and sensitive skin. By giving respective similarities in the user skin type and age attributes more weight, a current user can have a prioritized view of sets of evaluation information of other users with similar skin conditions earlier among the displayed evaluation information and use this information to determine whether the current product is suitable for him or her. Therefore, if the current product is in the cosmetics category, the similarities in the user skin type and age attributes can be weighted more heavily in the degree of attribute information match determination between the current user and the publisher user.

In a fourth example, as for products in the electronic products category, the current user, in viewing sets of evaluation information for the current product, may prefer to have a prioritized view of sets of evaluation information by publisher users with more expertise in the area of electronic products. Therefore, if the current product is in the electronic products category, the similarities in the user specialty, education, occupation, and/or sex attributes can be more heavily weighted in the degree of attribute information match determination between the current user and the publisher user.

As such, in some embodiments, the category of the current product can be referred to when determining the weight of a similarity associated with a certain attribute/dimension. After the product category to which the current product belongs is determined, the predetermined weights corresponding to different attributes for that product category can be determined and used in determining the degree of attribute information match between the current user and the publisher user. Thus, the order in which sets of evaluation information are presented to the current user can be customized based on the product category to which the current product belongs.

In some of the embodiments described above, the weights assigned to different attribute similarities may be different between different products and/or product categories and is helpful in emphasizing different types of attributes in prioritizing the presentation of sets of evaluation information. In some embodiments, product categories can be used to select which attributes/dimensions of the current user and a publisher user to use in determining the degree of attribute information match between the current user and the publisher user. In some embodiments, which attributes/dimensions to select and use in determining the degree of attribute information match between the current user and the publisher user are determined using the product category and preset attribute selection rules.

Below are examples of selecting attributes/dimensions to use in determining the degree of attribute information match between the current user and a publisher user based on the product category to which the current product belongs:

In a first example, if the current product is in the category of apparel or of shoes, then the attributes/dimensions of user height and weight may be selected to use in determining the degree of attribute information match between the current user and a publisher user. That is, the degree of attribute information match determination between the two users is calculated using the user height and weight attributes. Therefore, the publisher users of the sets of evaluation information that are prioritized to be presented to the current user are determined as having similar heights and weights to those of the current user. For example, assume that the current product is a piece of apparel. The height of the current user is 160 cm and her weight is 50 kg. In some embodiments, the sets of evaluation information that are prioritized to be presented to the current user can be sets of evaluation information that were published about this apparel by other users whose height is between 158 cm and 162 cm and whose weight is between 48 kg and 52 kg because these height and weight attributes are similar to those of the current user and therefore may be of greater interest to the current user in evaluating this piece of apparel.

In a second example, if the current product is a type of apparel or shoes with seasonal features/uses, such as, for example, a down coat or other apparel that is typically worn in the winter, the same down coat may have different evaluations from buyer users located in different geographical locations because the weather can differ greatly between different areas during the same season. For example, in China, the north is colder, and the south is warmer. Thus, a down coat of the same thickness may be evaluated as “too thin, not warm” by northern buyer users but yet may be evaluated as “very warm” by southern buyer users. Therefore, for a current product with seasonal features/uses, the attribute of geographical location may be selected to use in determining the degree of attribute information match between the current user and a publisher user. Thus, for a current product that is a type of apparel or shoes with seasonal features/uses, the publisher users of the sets of evaluation information that are prioritized to be presented to the current user are determined as being in a similar geographical location to that of the current user. For example, the current user in Hangzhou, Zhejiang searches for “down coats” on an e-commerce transaction platform. After selecting a certain down coat product from the search result, the detailed information page for the selected down coat product is accessed. The user then selects to view the “Detailed Evaluation Information” content at the detailed information page. By using at least some embodiments described herein, the sets of evaluation information for the selected down coat product that were submitted by publisher users who are also located in Hangzhou, Zhejiang can be prioritized in the presentation of evaluation information. Thus, the current user can view the evaluation content of other users in the same area first and use it as a basis for determining whether the thickness of the coat is suitable for use in Hangzhou.

In a third example, if the current product is in the cosmetics category, then the attribute of user skin type may be selected to use in determining the degree of attribute information match between the current user and a publisher user. Therefore, the publisher users of the sets of evaluation information that are prioritized to be presented to the current user are determined as having a similar skin type to that of the current user. So, for example, if the current user has dry skin, then sets of evaluation information that were submitted by publisher users with dry skin will be prioritized in the presentation of evaluation information for the current user. This ordering of evaluation information will be more valuable to the current user and can help the current user determine whether the cosmetics are suitable for his or her own use.

In a fourth example, if the current product is in the electronic products category, then the attributes of user specialty, education, occupation, and/or sex may be selected to use in determining the degree of attribute information match between the current user and a publisher user. Therefore, the publisher users of the sets of evaluation information that are prioritized to be presented to the current user are determined as having a similar level of understanding of electronic products as the current user.

In some embodiments, in determining a degree of attribute information match between a current user and each publisher user, the product category to which the current product belongs is first determined. Then, the attributes/dimensions to use in determining the degree of attribute information match between the current user and each publisher user can be selected based on a preset attribute selection rule associated with the determined product category. If there are multiple attributes selected, then the predetermined attribute similarity weights associated with the determined product category can be obtained and used to determine the degree of attribute information match between the current user and each publisher user.

In some embodiments, in addition to using the product category to which the current product belongs to select the attributes/dimensions attribute to use in determining the degree of attribute information match between the current user and a publisher user, the selected attributes/dimensions may be presented with the prioritized sets of evaluation information that are displayed for a current user to inform the current user the basis on which the prioritization was determined. For example, a label that includes the attributes/dimensions on which the prioritization was determined and the current user's values in those attributes/dimensions can be displayed with the presentation of the prioritized sets of evaluation information. For example, if the geographical location attribute was selected to be used for determining the degree of attribute information match between the current user and the publisher user and if the current user is from Hangzhou, Zhejiang, then the generated and presented label with the prioritized sets of evaluation information could be “Hangzhou, Zhejiang buyer evaluation content.” In another example, if the user skin type attribute was selected to use determining the degree of attribute information match between the current user and the publisher user and that the current user has dry skin, then the generated label could be “Dry skin buyer evaluation content.”

At 210, at least a subset of the plurality of evaluation information associated with the current product is presented based at least in part on respective degrees of attribute information match between the current user and each of the subset of the publisher users.

In various embodiments, the prioritization of the presentation of certain sets of evaluation information can be performed in various ways based on the degrees of attribute information match between publisher users of the sets of evaluation information and the current user.

In some embodiments, after the degree of attribute information match is determined between the current user and each publisher user associated with a set of evaluation information, those sets of evaluation information that are submitted by publisher users with degrees of attribute information match with the current user that meet a preset condition are sent to the client used by the current user and presented to the current user. For example, the preset condition can be a preset threshold degree of attribute information match value and therefore, only the sets of evaluation information that are submitted by publisher users with degrees of attribute information match with the current user that are equal or greater than the preset threshold degree of attribute information match value are presented for the current user.

In some embodiments, the sets of evaluation information are ranked based on their respective degrees of attribute information match and are presented in an order determined based on their respective rankings. As such, sets of evaluation information that were submitted by publisher users with higher degrees of attribute information match with the current user will be presented in higher rankings than sets of evaluation information that were submitted by publisher users with lower degrees of attribute information match with the current user.

In some embodiments, if no publisher user is determined to have a degree of attribute information match with the current user that is at least equal to the preset threshold degree of attribute information match, then all the sets of evaluation information are ranked based on the credit rating of each respective publisher user and presented for the current user based on the credit rating ranking.

In some embodiments, after the one or more attributes/dimensions over which similarities between the current user and a publisher user are selected and a similarity is determined between the current user and the publisher user with respect to each individual selected attribute/dimension, the similarities do not need to be weighted and summed together and instead, each similarity with respect to each individual selected attribute/dimension can be used as a corresponding degree of attribute information match in that particular attribute/dimension. For example, if it is determined that similarities are to be determined between the current user and each publisher user for the attributes of user age and user height, then the similarity between the current user and each publisher user with respect to the age attribute can be used as the degree of age match between the current user and each publisher user and the similarity between the current user and each publisher user with respect to the height attribute can be used as a separate, individual degree of height match between the current user and each publisher user. In presenting the sets of evaluation information to the current user at a user interface, a menu (e.g., a drop-down box) that lists each attribute/dimension for which a corresponding degree of attribute information match has been determined can be presented. The current user can select an attribute/dimension that is included in the menu and the sets of evaluation information can be ranked based on their publisher user's respective degree of attribute information match corresponding to the selected attribute with the current user and those sets of evaluation information that are ranked higher can be presented in a prioritized manner for the current user at the user interface. For example, if the menu included attributes “age” and “height” and the current user had selected “age,” then the displayed sets of evaluation information can be displayed a from high-to-low degree of age match rankings.

Process 200 describes screening and/or ranking sets of evaluation information associated with a current product based on determining the similarity between the publisher users who have authored the evaluation information and the current user. Therefore, the final presentation of the sets of evaluation information is customized for the particular current user.

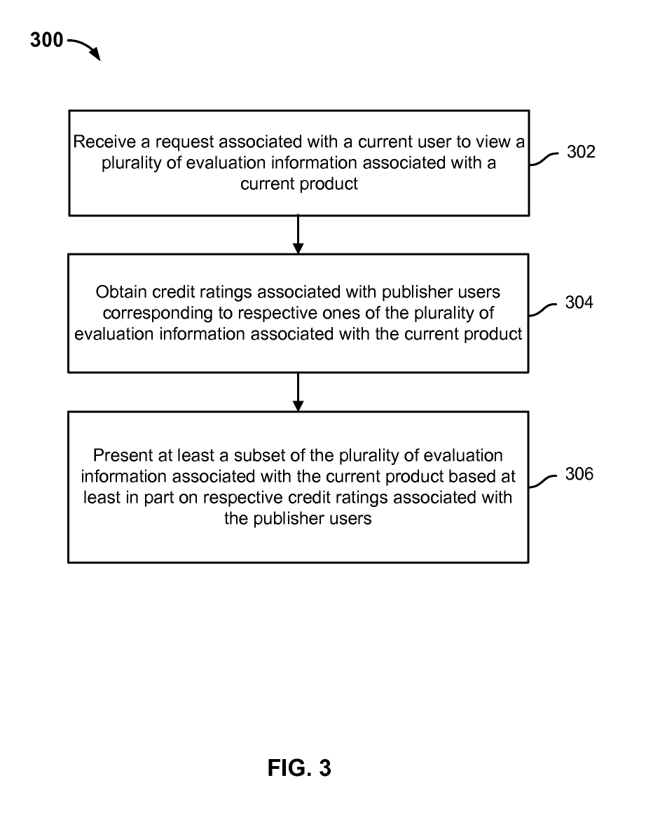

FIG. 3 is a flow diagram showing an embodiment of a process for customizing evaluation information presentation. In some embodiments, process 300 is implemented at system 100 of FIG. 1.

Process 300 describes an example of presenting sets of evaluation information submitted by publisher users for a current product for a current user based on the credit rating attribute of the publisher users. Because the credit rating of each user is the result of a comprehensive system assessment based on multiple user factors (e.g., payment history, purchase history, reviews submitted by the user, reviews of the user, etc.), a user with a high credit rating may be seen as a user who has more experience shopping at e-commerce transaction platforms and/or a user who is inclined to select superior sellers and superior products to purchase. Therefore, it is assumed that if the credit rating of a publisher user is higher, then the sets of evaluation information submitted by the publisher user will be more credible and useful.

Unlike process 200 of FIG. 2, process 300 may not necessarily retrieve and/or use the attribute information associated with the current user.

In some embodiments, process 300 may be applied if it is determined that none of the sets of evaluation information are submitted by publisher users with degrees of attribute information match with the current user that a preset condition (e.g., as determined using a process such as process 200 of FIG. 2).

At 302, a request associated with a current user to view a plurality of evaluation information associated with a current product is received. Step 302 can be performed similarly to step 202 of process 200 of FIG. 2.

At 304, credit ratings associated with publisher users corresponding to respective ones of the plurality of evaluation information associated with the current product are obtained.

In some embodiments, the credit rating of each publisher user that had submitted a set of evaluation information for the current product is retrieved. In some embodiments, a credit rating for a publisher user can be determined using similar techniques that were described in process 200 of FIG. 2 for obtaining attribute information for a user. In some embodiments, the credit rating for each publisher user is stored in server databases and can be looked up according to an account ID that belongs to the publisher user.

At 306, at least a subset of the plurality of evaluation information associated with the current product is presented based at least in part on respective credit ratings associated with the publisher users.

In some embodiments, the sets of evaluation information are ranked based on their respective publisher user's credit ratings, from high-to-low, and displayed in the ranked order at a user interface for the current user.

In some embodiments, only those sets of evaluation information for which respective publisher user's credit ratings are equal to or higher than the credit rating of the current user may be presented to the current user. The credit rating is an attribute of the current user that can be retrieved from storage.

In some embodiments, the sets of evaluation information for which respective publisher user's credit ratings are the same can be ranked and presented to the current user according to their respective publication times.

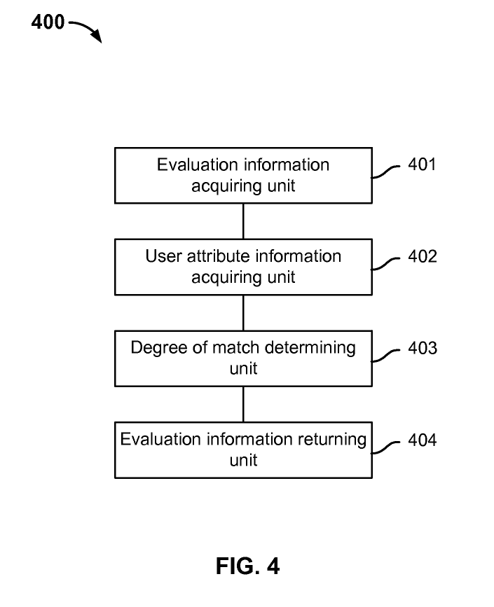

FIG. 4 is a diagram showing an embodiment of a system for customizing evaluation information presentation. In the example, system 400 includes evaluation information acquiring unit 401, user attribute information acquiring unit 402, degree of match determining unit 403, and evaluation information returning unit 404. In some embodiments, process 200 of FIG. 2 may be implemented at system 400.

The units and sub-units can be implemented as software components executing on one or more processors, as hardware such as programmable logic devices, and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units and sub-units may be implemented on a single device or distributed across multiple devices.

Evaluation information acquiring unit 401 is configured to obtain attribute information associated with a current user in response to receipt of a request associated with the current user to view sets of evaluation information for a current product. For example, the sets of evaluation information are to be displayed at a detailed information page associated with the current product. In some embodiments, evaluation information acquiring unit 401 is configured to obtain the sets of evaluation information associated with the current product.

User attribute information acquiring unit 402 is configured to obtain the user attribute information of the publisher user corresponding to each set of evaluation information.

Degree of match determining unit 403 is configured to determine the degree of attribute information match between the current user and each publisher user based on the attribute information associated with the current user and the attribute information associated with each publisher user.

Evaluation information returning unit 404 is configured to present the sets of evaluation information to the current user based at least in part on the degree of attribute information match between the current user and the publisher users of the respective sets of evaluation information.

In some embodiments, the attribute information obtained for the current user and each publisher user includes multiple attributes/dimensions. In some embodiments, degree of match determining unit 403 is configured to determine for each pair of the current user and a publisher user, a similarity between the two users with respect to each user's attributes/dimensions and then perform a weighted sum of the similarities of the attributes/dimensions to determine the degree of attribute information match between the two users. The similarity for each attribute may correspond to a predetermined weight.

In some embodiments, the weight of the similarity for an attribute/dimension can be determined according to the product category to which the current product belongs. In such cases, system 400 may further include:

A product category determining unit that is configured to determine the product category to which the current product belongs.

A first weight determining unit that is configured to determine the weight of each attribute/dimension according to the product category.

In some embodiments, when the attribute information obtained for the current user and each publisher user includes multiple attributes/dimensions, degree of match determining unit 403 may further include:

A product category determining sub-unit that is configured to determine the product category to which the current product belongs.

A target determining sub-unit that is configured to select the one or more attributes/dimensions according to the product category.

A degree of match determining sub-unit that is configured to determine the degree of attribute information match between the current user and each publisher user based on the one or more attributes/dimensions selected according to the product category.

If there are multiple selected attributes/dimensions, then system 400 may further comprise:

A second weight determining unit that is configured to determine the weight of each selected attribute/dimension according to the product category.

The degree of match determining sub-unit can be configured to determine for each pair of the current user and a publisher user, a similarity between the two users with respect to each of the selected attributes/dimensions and then perform a weighted sum of the similarities of the attributes/dimensions to determine the degree of attribute information match between the two users. The similarity for each attribute may correspond to a predetermined weight associated with the product category.

Regardless of whether degree of attribute match calculations are based on attribute information in all obtained attributes/dimensions or are based on attribute information in only the selected attributes/dimensions, the calculations of the degree of match between publisher users and a current user may use the following:

A similarity calculating unit that is configured to determine the similarity between the current user and each publisher user along each attribute/dimension.

A summing unit that is configured to weigh the computed similarity corresponding to each attribute for each pair of the current user and a publisher user and then sum together the weighted similarities for the two users to determine the degree of attribute information match between the publisher user and the current user.

In some embodiments, system 400 may further include:

A label generating unit that is configured to generate a label based on an attribute on which the degree of attribute information match is determined and also the current user's particular value for this attribute.

A label returning unit that is configured to present the generated label with the sets of evaluation information that have been presented based on the degrees of attribute information match associated with their respective publisher users.

In some other embodiments, degree of match determining unit 403 may further include:

A similarity calculating sub-unit that is configured to determine the similarity between the current user and each publisher user in each attribute/dimension.

A single-dimension degree of match determining sub-unit that is configured to use the determined similarity in each attribute/dimension as a corresponding degree of attribute information match between each publisher user and the current user.

Evaluation information returning unit 404 specifically may comprise:

A dimension-selecting information-receiving sub-unit that is configured to receive an attribute/dimension that is selected by the current user (e.g., from a menu of attributes/dimensions that is presented at the user interface).

A returning sub-unit that is configured to use the degree of attribute information match between each publisher user with the current user in a selected attribute/dimension as a basis for presenting the sets of evaluation information.

In some embodiments, evaluation information returning unit 404 is configured to present sets of evaluation information published by those publisher users whose degree of attribute match with the current user meets a preset condition.

In some embodiments, in the event that no publisher user has a degree of attribute information match that meets a preset condition, then sets of evaluation information are presented to the current user according to the credit rating of each publisher user.

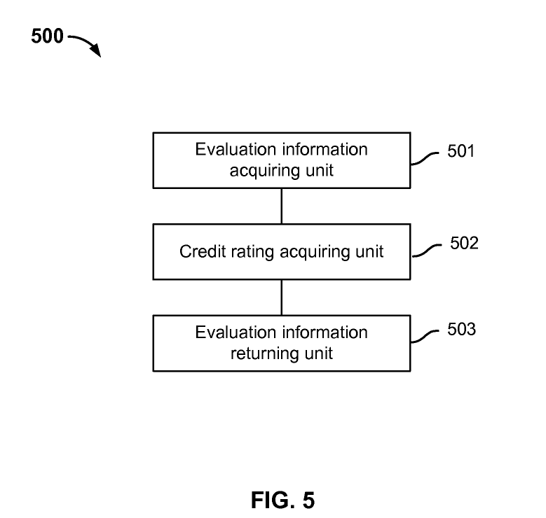

FIG. 5 is a diagram showing an embodiment of a system for customizing evaluation information presentation. In the example, system 500 includes evaluation information acquiring unit 501, credit rating acquiring unit 502, and evaluation information returning unit 503. In some embodiments, process 300 of FIG. 3 may be implemented at system 500.

Evaluation information acquiring unit 501 is configured to obtain attribute information associated with a current user in response to receipt of a request associated with the current user to view sets of evaluation information for a current product. For example, the sets of evaluation information are to be displayed at a detailed information page associated with the current product. In some embodiments, evaluation information acquiring unit 501 is configured to obtain the sets of evaluation information associated with the current product.

Credit rating acquiring unit 502 is configured to obtain the credit rating of each publisher user corresponding to each set of evaluation information.

Evaluation information returning unit 503 is configured to present the sets of evaluation information to the current user based at least in part on the credit ratings of the publisher users of the respective sets of evaluation information. In some embodiments, those sets of evaluation information submitted by publisher users with higher credit ratings are ranked higher and therefore presented earlier in presentation to the current user.

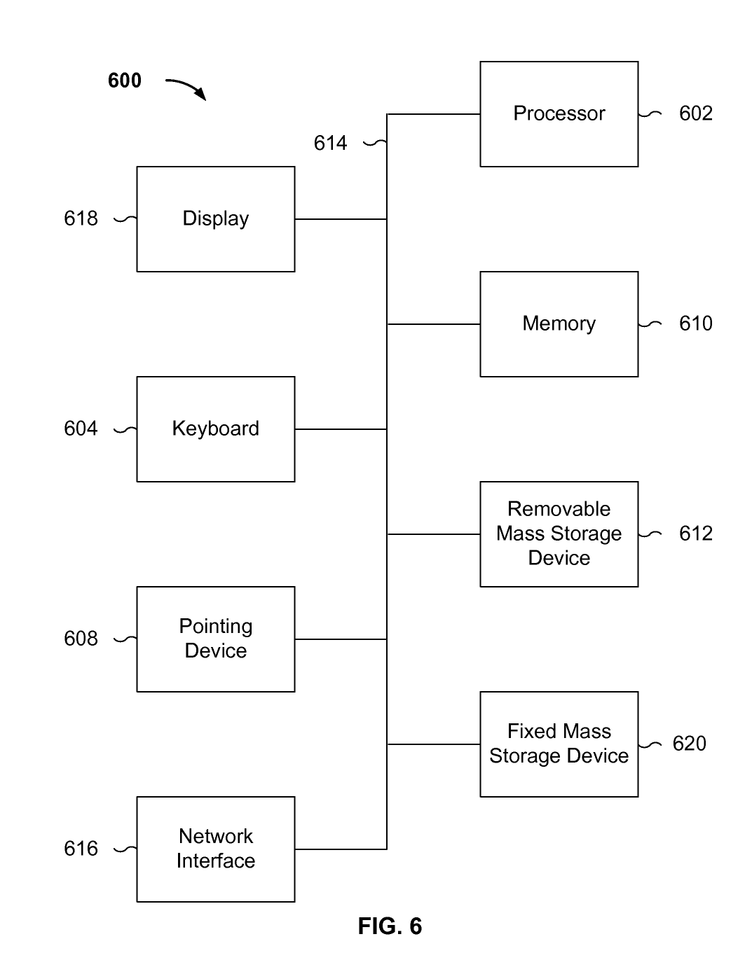

FIG. 6 is a functional diagram illustrating an embodiment of a programmed computer system for implementing customizing evaluation information presentation. As will be apparent, other computer system architectures and configurations can be used to customize evaluation information presentation. Computer system 600, which includes various subsystems as described below, includes at least one microprocessor subsystem (also referred to as a processor or a central processing unit (CPU)) 602. For example, processor 602 can be implemented by a single-chip processor or by multiple processors. In some embodiments, processor 602 is a general purpose digital processor that controls the operation of the computer system 600. Using instructions retrieved from memory 610, the processor 602 controls the reception and manipulation of input data, and the output and display of data on output devices (e.g., display 618). In some embodiments, processor 602 includes and/or is used to provide the customization of evaluation information presentation.

Processor 602 is coupled bi-directionally with memory 610, which can include a first primary storage area, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 602. Also as is well known in the art, primary storage typically includes basic operating instructions, program code, data, and objects used by the processor 602 to perform its functions (e.g., programmed instructions). For example, memory 610 can include any suitable computer readable storage media, described below, depending on whether, for example, data access needs to be bi-directional or uni-directional. For example, processor 602 can also directly and very rapidly retrieve and store frequently needed data in a cache memory (not shown).

A removable mass storage device 612 provides additional data storage capacity for the computer system 600 and is coupled either bi-directionally (read/write) or uni-directionally (read only) to processor 602. For example, storage 612 can also include computer readable media such as magnetic tape, flash memory, PC-CARDS, portable mass storage devices, holographic storage devices, and other storage devices. A fixed mass storage 620 can also, for example, provide additional data storage capacity. The most common example of fixed mass storage 620 is a hard disk drive. Mass storage 612, 620 generally store additional programming instructions, data, and the like that typically are not in active use by the processor 602. It will be appreciated that the information retained within mass storages 612 and 620 can be incorporated, if needed, in standard fashion as part of memory 610 (e.g., RAM) as virtual memory.

In addition to providing processor 602 access to storage subsystems, bus 614 can also be used to provide access to other subsystems and devices. As shown, these can include a display 618, a network interface 616, a keyboard 604, and a pointing device 608, as well as an auxiliary input/output device interface, a sound card, speakers, and other subsystems as needed. For example, the pointing device 608 can be a mouse, stylus, track ball, or tablet, and is useful for interacting with a graphical user interface.

The network interface 616 allows processor 602 to be coupled to another computer, computer network, or telecommunications network using a network connection as shown. For example, through the network interface 616, the processor 602 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 602 can be used to connect the computer system 600 to an external network and transfer data according to standard protocols. For example, various process embodiments disclosed herein can be executed on processor 602, or can be performed across a network such as the Internet, intranet networks, or local area networks, in conjunction with a remote processor that shares a portion of the processing. Additional mass storage devices (not shown) can also be connected to processor 602 through network interface 616.

An auxiliary I/O device interface (not shown) can be used in conjunction with computer system 600. The auxiliary I/O device interface can include general and customized interfaces that allow the processor 602 to send and, more typically, receive data from other devices such as microphones, touch-sensitive displays, transducer card readers, tape readers, voice or handwriting recognizers, biometrics readers, cameras, portable mass storage devices, and other computers.

All of the embodiments in the Description are described in progressive fashion. Where portions of an embodiment are the same or similar to those of another embodiment, it is sufficient to view the other. Each embodiment puts an emphasis on explaining those areas that are different from other embodiments. The above-described systems and system embodiments are merely illustrative. The units therein which are described as separate components may or may not be physically separate. Components that are depicted as units may or may not be physical units. They may be located in one place, or they may be distributed across multiple network units. A portion or all of the modules herein may be chosen based on actual requirements to achieve the objectives of the present embodiment scheme. Persons with ordinary skill in the art will be able to understand and implement it without expending creative effort.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
an evaluation information acquirer to:
receive a request associated with a current user to view a plurality of evaluation information associated with a current product; and
obtain attribute information associated with the current user;
a user attribute information determiner to obtain attribute information associated with publisher users corresponding to respective ones of the plurality of evaluation information associated with the current product;
a degree of matching determiner to determine a degree of attribute information match between the current user and each of a subset of the publisher users; and
an evaluation information returner to present at least a subset of the plurality of evaluation information associated with the current product based at least in part on respective degrees of attribute information match between the current user and each of the subset of the publisher users.

2. The system of claim 1, wherein the attribute information associated with the current user is retrieved from storage.

3. The system of claim 1, wherein the attribute information associated with the current user is extracted from one or more pieces of information submitted by the current user.

4. The system of claim 1, wherein the attribute information associated with the current user is determined from a stored client cookie.

5. The system of claim 1, wherein to determine the degree of attribute information match between the current user and each of the subset of the publisher users comprises to:
determine a set of attribute similarities between the current user and a publisher user based at least in part on comparing attribute information corresponding to one or more attributes associated with the current user and attribute information corresponding to the one or more attributes associated with the publisher user; and
determine a degree of attribute information match between the current user and the publisher user based at least in part on weighting the set of attribute similarities with a set of weights corresponding to the one or more attributes and combining the set of weighted similarities.

6. The system of claim 5, wherein the set of weights corresponding to the one or more attributes is determined based at least in part by:
determining a product category to which the current product belongs; and
determining the set of weights corresponding to the one or more attributes based on a preset attribute similarity weight rule and the product category.

7. The system of claim 5, wherein the one or more attributes are determined based at least in part by:
determining a product category to which the current product belongs; and
selecting the one or more attributes based on a preset attribute selection rule and the product category.

8. The system of claim 1, wherein to determine the degree of attribute information match between the current user and each of the subset of the publisher users and to present the at least subset of the plurality of evaluation information associated with the current product based at least in part on respective degrees of attribute information match between the current user and each of the subset of the publisher users comprises to:
determine a set of degrees of attribute information match between the current user and a publisher user based at least in part on comparing attribute information corresponding to one or more attributes associated with the current user and attribute information corresponding to the one or more attributes associated with the publisher user;
receive a selection associated with an attribute of the one or more attributes; and
rank the at least subset of the plurality of evaluation information based at least in part on degrees of attribute information match associated with the selected attribute.

9. The system of claim 1, wherein to present the at least subset of the plurality of evaluation information associated with the current product based at least in part on respective degrees of attribute information match between the current user and each of the subset of the publisher users comprises to:
generate a label associated with (1) an attribute on which the degrees of attribute information match between the current user and each of the subset of the publisher users is based and (2) the current user's value corresponding to the attribute; and
present the label with the subset of the plurality of evaluation information associated with the current product.

10. The system of claim 1, wherein to present the at least subset of the plurality of evaluation information associated with the current product based at least in part on respective degrees of attribute information match between the current user and each of the subset of the publisher users comprises to:
rank the least subset of the plurality of evaluation information associated with the current product in an order based at least in part on respective degrees of attribute information match between the current user and each of the subset of the publisher users; and
present at least a portion of the ranked evaluation information.

11. The system of claim 10, wherein the at least portion of the ranked evaluation information that is presented comprises evaluation information whose degrees of attribute information match between the current user and respective publisher users meet a preset condition.

12. The system of claim 1, wherein to present the at least subset of the plurality of evaluation information associated with the current product based at least in part on respective degrees of attribute information match between the current user and each of the subset of the publisher users comprises to:
determine that none of the degrees of attribute information match between the current user and each of the subset of the publisher users meets a preset condition; and
in response to the determination that none of the degrees of attribute information match between the current user and each of the subset of the publisher users meets the preset condition, rank the subset of the plurality of evaluation information associated with the current product based at least in part on each of the subset of the publisher users' respective credit rating.

13. A method, comprising:
receiving a request associated with a current user to view a plurality of evaluation information associated with a current product;
obtaining attribute information associated with the current user;
obtaining attribute information associated with publisher users corresponding to respective ones of the plurality of evaluation information associated with the current product;
determining, using a processor, a degree of attribute information match between the current user and each of a subset of the publisher users; and
presenting at least a subset of the plurality of evaluation information associated with the current product based at least in part on respective degrees of attribute information match between the current user and each of the subset of the publisher users.

14. The method of claim 13, wherein the attribute information associated with the current user is retrieved from storage.

15. The method of claim 13, wherein the attribute information associated with the current user is extracted from one or more pieces of information submitted by the current user.

16. The method of claim 13, wherein the attribute information associated with the current user is determined from a stored client cookie.

17. The method of claim 13, wherein determining the degree of attribute information match between the current user and each of the subset of the publisher users comprises:
determining a set of attribute similarities between the current user and a publisher user based at least in part on comparing attribute information corresponding to one or more attributes associated with the current user and attribute information corresponding to the one or more attributes associated with the publisher user; and
determining a degree of attribute information match between the current user and the publisher user based at least in part on weighting the set of attribute similarities with a set of weights corresponding to the one or more attributes and combining the set of weighted similarities.

18. The method of claim 17, wherein the set of weights corresponding to the one or more attributes is determined based at least in part by:
determining a product category to which the current product belongs; and
determining the set of weights corresponding to the one or more attributes based on a preset attribute similarity weight rule and the product category.

19. The method of claim 17, wherein the one or more attributes are determined based at least in part by:
determining a product category to which the current product belongs; and
selecting the one or more attributes based on a preset attribute selection rule and the product category.

20. A computer program product, the computer program product comprising a non-transitory compute readable storage medium and comprising computer instructions for:
receiving a request associated with a current user to view a plurality of evaluation information associated with a current product;
obtaining attribute information associated with the current user;
obtaining attribute information associated with publisher users corresponding to respective ones of the plurality of evaluation information associated with the current product;
determining a degree of attribute information match between the current user and each of a subset of the publisher users; and
presenting at least a subset of the plurality of evaluation information associated with the current product based at least in part on respective degrees of attribute information match between the current user and each of the subset of the publisher users.
